(19) United States
(12) Patent Application Publication
(10) Pub. No.: US 2024/0125374 A1
(43) Pub. Date: Apr. 18, 2024

(54) A NON-ORTHOGONAL ELLIPTICAL TOROIDAL WORM GEAR PAIR

(71) Applicant: DALIAN UNIVERSITY OF TECHNOLOGY, Dalian, Liaoning (CN)

(72) Inventors: Siying LING, Dalian, Liaoning (CN); Ming LING, Dalian, Liaoning (CN); Heng ZHANG, Dalian, Liaoning (CN); Fengtao WANG, Dalian, Liaoning (CN)

(21) Appl. No.: 18/016,805

(22) PCT Filed: May 11, 2022
(86) PCT No.: PCT/CN2022/092094

§ 371 Date: Jan. 18, 2023

(30) Foreign Application Priority Data
Mar. 28, 2022 (CN) 202210309326.7

(51) Int. Cl. F16H 1/16; F16H 55/08; F16H 55/22

(52) U.S. Cl. CPC F16H 1/16; F16H 55/0806; F16H 55/22; F16H 2057/0087

(57) ABSTRACT

The present invention belongs to the field of mechanical transmission technology, and proposes a non-orthogonal elliptical toroidal worm gear pair, including an involute cylindrical gear and an elliptical toroidal worm formed by a primary envelope of the involute cylindrical gear; both adopt spatial non-orthogonal transmission, and the shaft angle satisfies the self-locking condition and the restriction condition of minimum tooth top width; the toroidal generatrix of the elliptical toroidal worm is elliptical, which can increase the number of meshing teeth and the total length of instantaneous contact line. A non-orthogonal elliptical toroidal worm gear pair proposed in this invention has the characteristics of toroidal worm drive and can realize the whole facewidth of the gear to participate in the meshing drive. It can be used in the fields of precision continuous indexing transmission, continuous lapping of cylindrical gear tooth flank, and has good popularization application value and industrialization prospect.

### FIELD OF THE INVENTION

The present invention belongs to the field of mechanical transmission technology and relates to a non-orthogonal elliptical toroidal worm gear pair

### BACKGROUND

Worm drive is an important transmission mode of mechanical transmission, with the advantages of large transmission ratio, high load capacity, small impact load, smooth transmission, easy to achieve self-locking and other advantages in national defense, metallurgy, shipbuilding, construction, chemical and other industries are widely used. Taking a worm gear with a specific tooth flank as the generating wheel rotating around its axis, and making the blank of one toroidal worm rotate around the other axis, the two axes are staggered in space (usually 90 degrees) and the developed worm is an enveloping toroidal worm.

At present, enveloping toroidal worm drive is an excellent form of transmission with compact structure, large load capacity and good meshing performance. It is mostly instantaneous multi-tooth contact or line contact, so it can improve the load carrying capacity by 1.5-4 times under the same size compared with ordinary cylindrical worm drive. Under the condition of transmitting the same power and mass manufacturing, there will be 30%-50% cost-saving if the cylindrical worm gear is replaced by the toroidal worm. At present, the manufacturing cost of worm wheel is high, and the highest manufacturing accuracy is difficult to break through Class-3, while the involute cylindrical gear has achieved Class-3 or more processing accuracy, Represented by the High-precision Gear Laboratory of Dalian University of Technology, the international leading Class-1 precision involute cylindrical gear has been developed. With the lower surface roughness, higher precision and good lubrication conditions of the manufactured parts, the transmission efficiency of the toroidal worm transmission mechanism has been greatly improved.

It has been reported that the experimental transmission efficiency of TI worm (Toroid enveloping worm which involute holicoid generatrix) can be as high as 95%, and the transmission efficiency of worm gears processed in large quantities can also be above 80%. Due to the difficulty of manufacturing high-precision worm gears, helical cylindrical gears can be used instead of worm gears for TI worm drive in cases where the transmission and load-bearing performance requirements are not high. However, this type of TI worm drive is greatly influenced by the value of the helix angle. If a non-reasonable helix angle is selected, it will produce partial load in the transmission process, and after a reasonable helix angle is selected, the working area of helical cylindrical gear is concentrated at the middle section of facewidth, and not all the tooth flank in the direction of facewidth can participate in meshing, which will cause the tooth flank of the helical cylindrical gear to wear unevenly in the meshing transmission process with the worm, resulting in the problem of decreasing transmission accuracy.

### SUMMARY

In order to solve the problems existing in TI worm drive process in the prior art, the invention provides a non-orthogonal elliptic toroidal worm gear pair, which has the characteristics of toroidal worm drive and can realize the whole facewidth of the gear to participate in meshing drive. Compared with the TI worm drive of helical cylindrical gears, the non-orthogonal elliptical toroidal worm gear pair provided by the invention has the advantages of smooth transmission, low impact, low noise, high load capacity, high transmission efficiency, significant error homogenization effect of multi-tooth transmission, uniform wear of gear tooth flank, and good accuracy retention, which can be used in the fields of precision continuous indexing transmission, comprehensive deviation measurement of elliptical toroidal worm, and continuous grinding and processing of cylindrical gear tooth flank.

In order to achieve the above purpose, the specific technical solutions are as follows:

A non-orthogonal elliptical toroidal worm gear pair comprising an involute cylindrical gear and an elliptical toroidal worm generating from a primary envelope of the involute cylindrical gear.

The involute cylindrical gear includes involute spur gear and involute helical gear; The tooth flank of the involute spur cylindrical gear is the involute cylindrical surface formed by the involute stretching along the axial direction, the tooth flank of the involute helical gear is the involute helicoid formed by the involute doing spiral movement along the axial direction, the involute is generated by the generating line doing pure rolling on the base circle; the involute cylindrical gear is ground and shaped by the hard tooth flank wear-resistant material.

The equations of the left flank of the involute cylindrical gear are as follows:

$$\{ \begin{matrix}{x}_{1 L} = {r}_{b} cos ( u - {σ}_{0} - {α}_{1} λ ) + {r}_{b} u sin ( u - {σ}_{0} - {α}_{1} λ ) \\ {y}_{1 L} = - {r}_{b} sin ( u - {σ}_{0} - {α}_{1} λ ) + {r}_{b} u cos ( u - {σ}_{0} - {α}_{1} λ ) \\ {z}_{1 L} = {α}_{1} {ρ}_{1} λ + {α}_{2} {h}_{L}\end{matrix}$$

where, x_{1L} is the x coordinate of each point on the left tooth surface, y_{1L} is the y coordinate of each point on the left tooth surface, z_{1L} is the z coordinate of each point on the left tooth surface; r_{b} is the radius of the base circle of the involute gear; u is the rolling angle formed by the dominant involute tooth profile; σ₀ is half of the base circular angle corresponding to the transverse base thickness of the involute cylindrical gear; h_{L} is the axial parameter of the tooth flank; σ₁ is the helical parameter; λ is the angle at which the involute makes a spiral motion along the axial direction; α₁ is the parameter taking the value of 0 or 1; α₂ is the parameter taking the value of 0 or 1.

The equations of the right flank of the involute cylindrical gear are as follows:

$$\{ \begin{matrix}{x}_{1 R} = {r}_{b} cos ( u - {σ}_{0} + {α}_{1} λ ) + {r}_{b} u sin ( u - {σ}_{0} + {α}_{1} λ ) \\ {y}_{1 R} = {r}_{b} sin ( u - {σ}_{0} + {α}_{1} λ ) - {r}_{b} u cos ( u - {σ}_{0} + {α}_{1} λ ) \\ {z}_{1 R} = {α}_{1} {ρ}_{1} λ + {α}_{2} {h}_{R}\end{matrix}$$

where, x_{1R} is the x coordinate of each point on the right flank, y_{1R} is the y coordinate of each point on the right flank, z_{1R} is the z coordinate of each point on the right flank; h_{R} is the right flank axial parameter.

When the tooth flank equations of the above involute cylindrical gear satisfies α₁=0 and α₂=1, the corresponding left and right tooth flank equations are the tooth flank equations of the involute spur cylindrical gear; similarly, when α₁=1 and α₂=0, the corresponding left and right tooth flank equations are the tooth flank equations of the involute helical cylindrical gear.

The reference surface of the conventional toroidal worm is toroid, while the reference surface of the elliptical toroidal worm described in the present invention is an elliptical toroidal surface, the generatrix of the elliptical toroidal surface is the intersection line between the inclined section and the reference cylinder within the working length of the worm, the inclined section passes through the axis of rotation of the elliptical toroidal worm and the angle with the horizontal plane is the shaft angle ε; the equations satisfied by the generatrix of the elliptical toroidal surface is as follows:

$$\frac{{y}^{2}}{{( r csc ε )}^{2}} + \frac{{x}^{2}}{{r}^{2}} = 1$$

where, r is the radius of the base circle of the involute reference cylinder, x is the x-coordinate of any point on the generatrix, y is the y-coordinate of any point on the generatrix.

The elliptical toroidal worm and involute cylindrical gear adopt spatially non-orthogonal transmission, and the shaft angle is determined according to the self-locking condition; as the shaft angle increases, the tooth top width of the elliptical toroidal worm gradually decreases, and the agreed minimum width is not less than 0.35 times the transverse modulus, at which time the shaft angle achieves the maximum value; the facewidth of the involute cylindrical gear is related to the working length of the elliptical toroidal worm and the shaft angle, and in order to achieve the whole facewidth of the involute cylindrical gear participating in the mesh, the following relationship should be satisfied:

b=L sin ε

where, b is the facewidth of the involute cylindrical gear, L is the working length of the elliptical toroidal worm gear.

The tooth flank of the elliptical toroidal worm is made of the involute spur gear's involute cylindrical surface or involute helical gear's involute helicoid as the tool generatrix surface according to the envelope method, and the corresponding transmission coordinate system is established according to the position relationship between the involute cylindrical gear and the elliptical toroidal worm mesh transmission. The details are as follows: the equations of the tooth flank of the involute cylindrical gear is obtained by the coordinate transformation and the principle of tooth conjugate meshing of the elliptical toroidal worm, the transmission subsets are ground and shaped with hard tooth material, so the equations of the tooth surface on the upper side of the elliptical toroidal worm is as follows:

$$\{ \begin{matrix}\begin{matrix}{x}_{2 L} = ( {x}_{1 L} cos {φ}_{1} - {y}_{1 L} sin {φ}_{1} - a ) cos {φ}_{2} + \\ [ ( {x}_{1 L} sin {φ}_{1} + {y}_{1 L} cos {φ}_{1} ) cos ε + {z}_{1 L} sin ε ] sin {φ}_{2}\end{matrix} \\ \begin{matrix}{y}_{2 L} = [ ( {x}_{1 L} sin {φ}_{1} + {y}_{1 L} cos {φ}_{1} ) cos ε + {z}_{1 L} sin ε ] cos {φ}_{2} - \\ ( {x}_{1 L} cos {φ}_{1} - {y}_{1 L} sin {φ}_{1} - a ) sin {φ}_{2}\end{matrix} \\ {z}_{2 L} = - ( {x}_{1 L} sin {φ}_{1} + {y}_{1 L} cos {φ}_{1} ) sin ε + {z}_{1 L} cos ε \\ {x}_{1 L} = {r}_{b} cos τ + {r}_{b} u sin τ \\ {y}_{1 L} = - {r}_{b} sin τ + {r}_{b} u cos τ \\ {z}_{1 L} = {α}_{1} {ρ}_{1} λ + {α}_{2} {h}_{L} \\ τ = u - {σ}_{0} - {α}_{1} λ \\ {h}_{L} = \frac{{r}_{b} ( {i}_{12} - cos ε ) + a cos ( u - {σ}_{0} - {φ}_{1} ) cos ε}{- sin ( u - {σ}_{0} - {φ}_{1} ) sin ε} \\ u = \frac{\begin{matrix}- {r}_{b}^{2} cos ( τ - {φ}_{1} ) sin ε + {ρ}_{1}^{2} ( τ + {σ}_{0} ) sin ( τ - {φ}_{1} ) sin ε - \\ {ρ}_{1} a cos ( τ - {φ}_{1} ) cos ε - {r}_{b} {ρ}_{1} ( {i}_{12} - cos ε ) + {r}_{b} a sin ε\end{matrix}}{( {r}_{b}^{2} + {ρ}_{1}^{2} ) sin ( τ - {φ}_{1} ) sin ε}\end{matrix}$$

where, a is the spread center distance; φ₁ is the rotation angle of the involute cylindrical gear; φ₂ is the rotation angle of elliptical toroidal worm; i₁₂ is the reciprocal of the transmission ratio of the worm gear pair; σ₀ is half of the base circular angle corresponding to the transverse base thickness of the involute cylindrical gear; u is the rolling angle formed by the dominant involute tooth profile.

Similarly, the equations of the lower side tooth surface of the elliptical toroidal worm are as follows:

$$\{ \begin{matrix}\begin{matrix}{x}_{2 R} = ( {x}_{1 R} cos {φ}_{1} - {y}_{1 R} sin {φ}_{1} - a ) cos {φ}_{2} + \\ [ ( {x}_{1 R} sin {φ}_{1} + {y}_{1 R} cos {φ}_{1} ) cos ε + {z}_{1 R} sin ε ] sin {φ}_{2}\end{matrix} \\ \begin{matrix}{y}_{2 R} = [ ( {x}_{1 R} sin {φ}_{1} + {y}_{1 R} cos {φ}_{1} ) cos ε + {z}_{1 R} sin ε ] cos {φ}_{2} - \\ ( {x}_{1 R} cos {φ}_{1} - {y}_{1 R} sin {φ}_{1} - a ) sin {φ}_{2}\end{matrix} \\ {z}_{2 R} = - ( {x}_{1 R} sin {φ}_{1} + {y}_{1 R} cos {φ}_{1} ) sin ε + {z}_{1 R} cos ε \\ {x}_{1 R} = {r}_{b} cos ( τ ) + {r}_{b} u sin ( τ ) \\ {y}_{1 R} = {r}_{b} sin ( τ ) - {r}_{b} u cos ( τ ) \\ {z}_{1 R} = {α}_{1} {ρ}_{1} λ + {α}_{2} {h}_{R} \\ τ = u - {σ}_{0} + {α}_{1} λ \\ {h}_{R} = \frac{{r}_{b} ( {i}_{12} - cos ε ) + a cos ( u - {σ}_{0} + {φ}_{1} ) cos ε}{sin ( u - {σ}_{0} + {φ}_{1} ) sin ε} \\ u = \frac{\begin{matrix}- {r}_{b}^{2} cos ( τ + {φ}_{1} ) sin ε + {ρ}_{1}^{2} ( τ + {σ}_{0} ) sin ( τ + {φ}_{1} ) sin ε - \\ {ρ}_{1} a cos ( τ + {φ}_{1} ) cos ε - {r}_{b} {ρ}_{1} ( {i}_{12} - cos ε ) + {r}_{b} a sin ε\end{matrix}}{( {r}_{b}^{2} + {ρ}_{1}^{2} ) sin ( τ + {φ}_{1} ) sin ε}\end{matrix}$$

The above tooth equations is determined by two parameters φ₁ and u, other parameters are known, and upper tooth surface and lower tooth surface of elliptical toroidal gear vice can be obtained by MATLAB numerical analysis and 3D modeling software in the range of φ₁ and u, and then they are stitched with the top toroidal surface and root toroidal surface of elliptical toroidal worm to generate the 3D solid model of non-orthogonal elliptical toroidal worm gear pair, and then the non-orthogonal elliptical toroidal worm gear pair is obtained.

The beneficial effects of the present invention are as follows:

(1) The present invention proposes a non-orthogonal elliptical toroidal worm gear pair with the characteristics of toroidal worm transmission, which can realize the whole facewidth of gears involved in meshing transmission.

(2) Compared with the traditional TI worm gear drive of helical cylindrical gear, the non-orthogonal elliptical toroidal worm gear pair has the advantages of smooth transmission, small impact, low noise, large load capacity, high transmission efficiency, significant error homogenization effect of multi-tooth transmission. It can be used in the fields of precision continuous indexing transmission, comprehensive deviation measurement of elliptical toroidal worm, continuous grinding and processing of cylindrical gear teeth, etc. It has good promotion value and industrialization prospect.

### BRIEF DESCRIPTIONS OF THE DRAWINGS

FIG. 1 Schematic diagram of the elliptical toroidal generatrix of an elliptical toroidal worm;

FIG. 2 Schematic diagram of the tooth flank structure of an involute spur cylindrical gear;

FIG. 3 Schematic diagram of the coordinate system of elliptical toroidal worm drive;

FIG. 4 Schematic diagram of elliptical toroidal worm gear tooth flank;

FIG. 5 Schematic diagram of involute spur cylindrical gear meshing with elliptical toroidal worm drive;

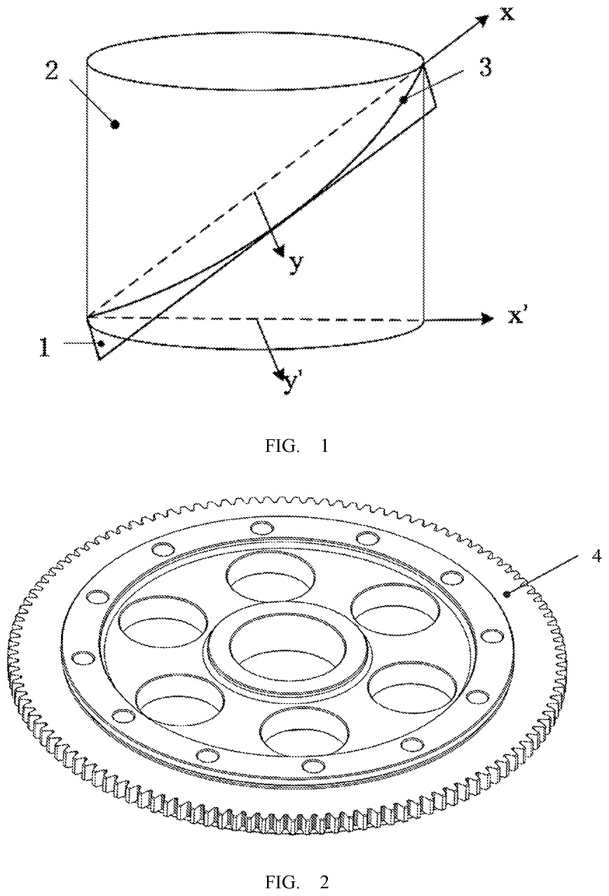

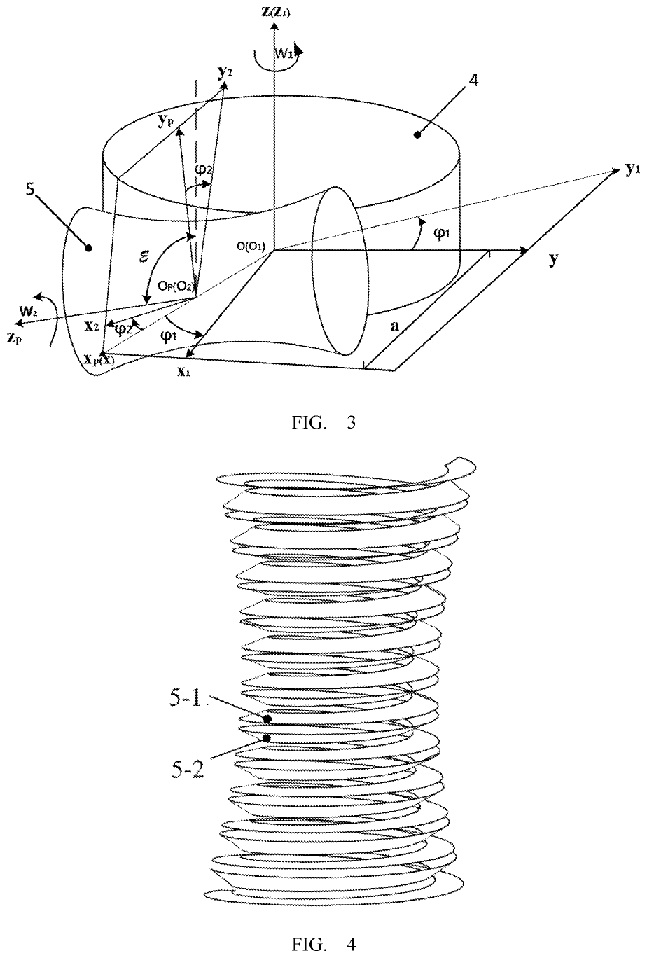

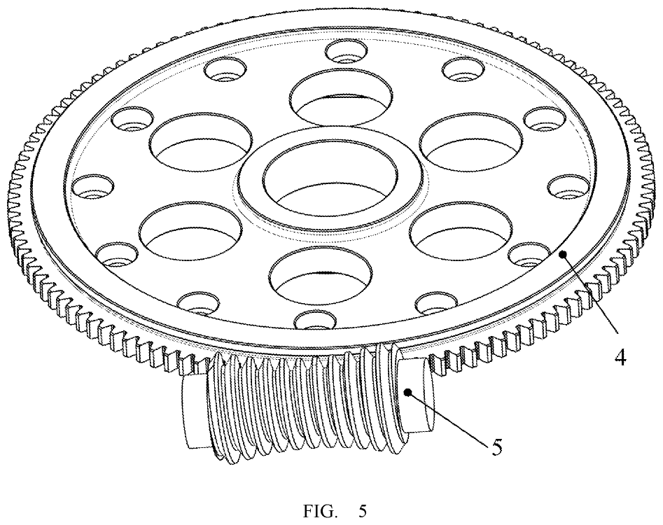

wherein, 1 illustrates inclined section; 2 illustrates the reference cylinder of involute cylindrical gear; 3 illustrates an elliptical toroidal generatrix; 4 illustrates an involute spur cylindrical gear; illustrates an elliptic toroidal worm; 5-1 illustrates an upper tooth surface of elliptic toroidal worm; 5-2 illustrates a lower tooth surface of elliptic toroidal worm.

### DETAILED DESCRIPTION

Taking an involute spur cylindrical gear with a modulus m=2 mm, a tooth number z=120 and a pressure angle α=20°, and an elliptical toroidal worm formed by a primary envelope of the involute cylindrical gear as an example, the technical solution is specified in conjunction with the attached drawings.

First, the reference surface of elliptical toroidal worm 5 is an elliptical toroidal surface, which is different from the conventional circular toroidal worm. The intersection line of the inclined section 1 and the gear reference cylinder surface 2 is the generatrix 3 of the elliptical toroidal surface, and the projection of the generatrix 3 on the cylindrical end face is a circular arc. The angle between the inclined section and the cylindrical end face is the shaft angle s of the transmission sub, and the radius of the cylindrical base circle is r. Then the equation of the cylindrical base circle is as follows:

x′²+y′²=r²

So, the equation satisfied by the generatrix 3 of the elliptical torus is as follows:

$$\frac{{x}^{2}}{{( r csc ε )}^{2}} + \frac{{y}^{2}}{{r}^{2}} = 1$$

When r=118 mm and r=122.5 mm, the above equations of generatrix 3 correspond to the equations of the top generatrix and root generatrix of the elliptical toroidal worm gear respectively.

Further, the working length, axis of rotation and other parameters of the elliptical toroidal worm 5 are determined based on the parameters of the involute spur cylindrical gear 4. The facewidth of the involute spur cylindrical gear 4 is related to the working length of the elliptical toroidal worm 5 and the shaft angle, in order to achieve the whole facewidth of the involute spur cylindrical gear to participate in the meshing needs to meet the following relationship:

b=L sin ε

The working length L of the elliptical toroidal worm is 72 mm and the facewidth b of the involute cylindrical gear is 8 mm when the selected shaft angle is 5° under the constraints of the self-locking condition and the minimum tooth top width of the worm.

The involute spur cylindrical gear 4 is ground and shaped with hardened wear-resistant material, and the left flank equations of the involute spur cylindrical gear 4 is as follows:

$$\{ \begin{matrix}{x}_{1 L} = {r}_{b} cos ( u - {σ}_{0} ) + {r}_{b} u sin ( u - {σ}_{0} ) \\ {y}_{1 L} = - {r}_{b} sin ( u - {σ}_{0} ) + {r}_{b} u cos ( u - {σ}_{0} ) \\ {z}_{1 L} = {h}_{L}\end{matrix}$$

where, r_{b} is the radius of the base circle of the involute cylindrical gear, the size of 112.7631 mm; u is the rolling angle formed by the dominant involute tooth profile, the value range is [0.2649,0.3850]; σ₀ is half of the base circular angle corresponding to the transverse base thickness of the involute cylindrical gear, the size of 1.6043°; h is the tooth flank axial parameter, which is related to the rolling angle u and the angle φ₁ of the elliptical toroidal worm gear.

Similarly, the equations of the right flank of the involute spur cylindrical gear 4 is as follows:

$$\{ \begin{matrix}{x}_{1 R} = {r}_{b} cos ( u - {σ}_{0} ) + {r}_{b} u sin ( u - {σ}_{0} ) \\ {y}_{1 R} = {r}_{b} sin ( u - {σ}_{0} ) - {r}_{b} u cos ( u - {σ}_{0} ) \\ {z}_{1 R} = {h}_{R}\end{matrix}$$

The tooth flank of the involute spur cylindrical gear 4 is used as the tool generatrix surface, and the tooth flank equations of the elliptical toroidal worm 5 are formed according to the generating method envelope. In the established elliptical toroidal worm space drive coordinate system, the coordinate systems σ(o; x, y, z) and σₚ(oₚ; xₚ, yₚ, zₚ) represent the starting positions of elliptical toroidal worm 5 and worm wheel—involute straight cylindrical gear 4, respectively, which are fixed coordinate systems. z and zₚ are the elliptical toroidal worm 5 and the two axes are non-orthogonal in space and the shaft angle is ε. The xₚ-axis and x-axis are in the same line and in the same direction. σ₁(o₁; x₁, y₁, z₁) and σ₂(o₂; x₂, y₂, z₂) denote the dynamic coordinate systems fixed to the spur cylindrical gear 4 and the elliptical toroidal worm 5, respectively, the spur cylindrical gear 4 and the elliptical toroidal worm 5 are rotated with angular velocities w₁ and w₂ rotate around z₁ and z₂ axes respectively, and the angle of rotation is φ₁ and φ₂ respectively, and the starting position is at φ₁=0 and φ₂=0. The shortest distance between z₁ and z₂ axes is a, which is the center distance of spur gear 4 and elliptical toroidal worm 5, and its value is 135 mm.

The tooth flank equations of elliptical toroidal worm 5 is obtained from the tooth equations of involute spur cylindrical gear 4 by transformation of the spatial coordinate system, and the coordinate transformation matrix M₁₂ of the spatial coordinate system is as follows:

$${M}_{12} = [ \begin{matrix}cos {φ}_{2} & sin {φ}_{2} & 0 & 0 \\ - sin {φ}_{2} & cos {φ}_{2} & 0 & 0 \\ 0 & 0 & 1 & 0 \\ 0 & 0 & 0 & 1\end{matrix} ]$$

$$[ \begin{matrix}1 & 0 & 0 & 0 \\ 0 & sin ε & - cos ε & 0 \\ 0 & cos ε & sin ε & 0 \\ 0 & 0 & 0 & 1\end{matrix} ] [ \begin{matrix}1 & 0 & 0 & - α \\ 0 & 0 & 1 & 0 \\ 0 & - 1 & 0 & 0 \\ 0 & 0 & 0 & 1\end{matrix} ] [ \begin{matrix}cos {φ}_{1} & - sin {φ}_{1} & 0 & 0 \\ sin {φ}_{1} & cos {φ}_{1} & 0 & 0 \\ 0 & 0 & 1 & 0 \\ 0 & 0 & 0 & 1\end{matrix} ]$$

The angle φ₁ of the elliptical toroidal worm is calculated to be in the range of [−17.25°,17.25°], which is related to its working half angle.

In the process of spatial conjugate meshing, the two tooth flanks participating in the mesh are in tangential contact at any instant, and there is always a common tangent plane at the tangent point, there is the same normal n. The equation of meshing satisfied at the contact is as follows:

v×n=0

where v is the relative velocity of the conjugate tooth flank at the meshing point.

This ensures that the two meshing tooth flanks can slide into contact continuously without interfering with each other. After satisfying the above requirements, the equations of the upper side tooth surface of elliptical toroidal worm 5 are as follows:

$$\{ \begin{matrix}\begin{matrix}{x}_{2 L} = ( {x}_{1 L} cos {φ}_{1} - {y}_{1 L} sin {φ}_{1} - a ) cos {φ}_{2} + \\ [ ( {x}_{1 L} sin {φ}_{1} + {y}_{1 L} cos {φ}_{1} ) cos ε + {z}_{1 L} sin ε ] sin {φ}_{2}\end{matrix} \\ \begin{matrix}{y}_{2 L} = [ ( {x}_{1 L} sin {φ}_{1} + {y}_{1 L} cos {φ}_{1} ) cos ε + {z}_{1 L} sin ε ] cos {φ}_{2} - \\ ( {x}_{1 L} cos {φ}_{1} - {y}_{1 L} sin {φ}_{1} - a ) sin {φ}_{2}\end{matrix} \\ {z}_{2 L} = - ( {x}_{1 L} sin {φ}_{1} + {y}_{1 L} cos {φ}_{1} ) sin ε + {z}_{1 L} cos ε \\ {x}_{1 L} = {r}_{b} cos ( u - {σ}_{0} ) + {r}_{b} u sin ( u - {σ}_{0} ) \\ {y}_{1 L} = - {r}_{b} sin ( u - {σ}_{0} ) + {r}_{b} u cos ( u - {σ}_{0} ) \\ {z}_{1 L} = {h}_{L} \\ {h}_{L} = \frac{{r}_{b} ( {i}_{12} - cos ε ) + a cos ( u - {σ}_{0} - {φ}_{1} ) cos ε}{- sin ( u - {σ}_{0} - {φ}_{1} ) sin ε}\end{matrix}$$

Similarly, the equations of the lower side tooth surface of the elliptical toroidal worm 5 is as follows:

$$\{ \begin{matrix}\begin{matrix}{x}_{2 R} = ( {x}_{1 R} cos {φ}_{1} - {y}_{1 R} sin {φ}_{1} - a ) cos {φ}_{2} + \\ [ ( {x}_{1 R} sin {φ}_{1} + {y}_{1 R} cos {φ}_{1} ) cos ε + {z}_{1 R} sin ε ] sin {φ}_{2}\end{matrix} \\ \begin{matrix}{y}_{2 R} = [ ( {x}_{1 R} sin {φ}_{1} + {y}_{1 R} cos {φ}_{1} ) cos ε + {z}_{1 R} sin ε ] cos {φ}_{2} - \\ ( {x}_{1 R} cos {φ}_{1} - {y}_{1 R} sin {φ}_{1} - a ) sin {φ}_{2}\end{matrix} \\ {x}_{2 R} = - ( {x}_{1 R} sin {φ}_{1} + {y}_{1 R} cos {φ}_{1} ) sin ε + {z}_{1 R} cos ε \\ {x}_{1 R} = {r}_{b} cos ( u - {σ}_{0} ) + {r}_{b} u sin ( u - {σ}_{0} ) \\ {y}_{1 R} = {r}_{b} sin ( u - {σ}_{0} ) - {r}_{b} u cos ( u - {σ}_{0} ) \\ {z}_{1 R} = {h}_{R} \\ {h}_{R} = \frac{{r}_{b} ( {i}_{12} - cos ε ) + a cos ( u - {σ}_{0} + {φ}_{1} ) cos ε}{sin ( u - {σ}_{0} + {φ}_{1} ) sin ε}\end{matrix}$$

The above tooth equations are determined by two parameters φ₁ and u, other parameters are known, and upper tooth surface 5-1 and lower tooth surface 5-2 of elliptical toroidal gear pair can be obtained by MATLAB numerical analysis and 3D modeling software such as UG or Pro/E in the range of φ₁ and u, and then they are stitched with the top toroidal surface and root toroidal surface of elliptical toroidal worm to generate the 3D solid model of non-orthogonal elliptical toroidal worm gear pair; after the 3D solid model is assembled with the involute cylindrical spur gear, the upper tooth surface 5-1 and lower tooth surface 5-2 of elliptical toroidal worm are in contact with the gear tooth flank and there is no tooth flank interference, which verifies the feasibility of this transmission form.

The transmission ratio adopted in this example is 120, and the number of teeth of involute cylindrical gear 4 involved in meshing at the same time is 12, so it has a good error equalization effect; when the shaft angle takes the maximum value of 7.7°, the facewidth of whole tooth contact of involute cylindrical gear can reach 9.65 mm, and the gear tooth flank wear is uniform and the accuracy retention is good, which can be used in precision continuous indexing transmission, comprehensive deviation measurement of elliptical toroidal worm, continuous grinding and processing of cylindrical gear tooth flank, etc. So, it has good popularization application value and industrialization prospect.

Finally, the above embodiments are only used to illustrate the technical solution of the present invention and not to limit it. To a person of ordinary skill in the art, equivalent substitutions or changes can be made according to the technical solution of the patent of the present invention and its specific embodiments, and all such changes or substitutions shall fall within the scope of protection of the patent of the present invention.

1. A non-orthogonal elliptical toroidal worm gear pair, which is characterized in that the non-orthogonal elliptical toroidal worm gear pair comprising an involute cylindrical gear and an elliptical toroidal worm spreading from a single-envelope of the involute cylindrical gear;
the involute cylindrical gear includes involute spur gear and involute helical gear; the tooth flank of the involute spur cylindrical gear is the involute cylindrical surface formed by the involute stretching along the axial direction, the tooth flank of the involute helical gear is the involute helicoid formed by the involute doing spiral movement along the axial direction, the involute is generated by the generating line doing pure rolling on the base circle; the involute cylindrical gear is ground and shaped by the hard tooth flank wear-resistant material;
the equations of the left flank of the involute cylindrical gear are as follows:
$$\{ \begin{matrix}{x}_{1 L} = {r}_{b} cos ( u - {σ}_{0} - {α}_{1} λ ) + {r}_{b} u sin ( u - {σ}_{0} - {α}_{1} λ ) \\ {y}_{1 L} = - {r}_{b} sin ( u - {σ}_{0} - {α}_{1} λ ) + {r}_{b} u cos ( u - {σ}_{0} - {α}_{1} λ ) \\ {z}_{1 L} = {α}_{1} {ρ}_{1} λ + {α}_{2} {h}_{L}\end{matrix}$$
where, x_{1L} is the x coordinate of each point on the left tooth surface, y_{1L} is the y coordinate of each point on the left tooth surface, z_{1L} is the z coordinate of each point on the left tooth surface; r_{b} is the radius of the base circle of the involute gear; u is the rolling angle formed by the dominant involute tooth profile; a σ₀ is half of the base circular angle corresponding to the transverse base thickness of the involute cylindrical gear; h_{L} is the axial parameter of the tooth flank; ρ₁ is the helical parameter; λ is the angle at which the involute makes a spiral motion along the axial direction; α₁ is the parameter taking the value of 0 or 1, α₂ is the parameter taking the value of 0 or 1;
the equations of the right flank of the involute cylindrical gear are as follows:
$$\{ \begin{matrix}{x}_{1 R} = {r}_{b} cos ( u - {σ}_{0} + {α}_{1} λ ) + {r}_{b} u sin ( u - {σ}_{0} + {α}_{1} λ ) \\ {y}_{1 R} = {r}_{b} sin ( u - {σ}_{0} + {α}_{1} λ ) - {r}_{b} u cos ( u - {σ}_{0} + {α}_{1} λ ) \\ {z}_{1 R} = {α}_{1} {ρ}_{1} λ + {α}_{2} {h}_{R}\end{matrix}$$
where, x_{1R} is the x coordinate of each point on the right flank, y_{1R} is the y coordinate of each point on the right flank, z_{1R} is the z coordinate of each point on the right flank; h_{R} is the right flank axial parameter;
when the tooth flank equations of the above involute cylindrical gear satisfies α₁=0 and α₂=1, the corresponding left and right tooth flank equation is the tooth flank equation of the involute spur cylindrical gear; similarly, when α₁=1 and α₂=0, the corresponding left and right tooth flank equation is the tooth flank equations of the involute helical cylindrical gear;
the reference surface of the elliptical toroidal worm described in the present invention is an elliptical toroidal surface, the generatrix of the elliptical toroidal surface is the intersection line between the inclined section and the reference cylinder within the working length of the worm, the inclined section passes through the axis of rotation of the elliptical toroidal worm and the angle with the horizontal plane is the shaft angle ε; the equation satisfied by the generatrix of the elliptical toroidal surface is as follows:
$$\frac{{y}^{2}}{{( r csc ε )}^{2}} + \frac{{x}^{2}}{{r}^{2}} = 1$$
where, r is the radius of the base circle of the involute indexing cylinder, x is the x-coordinate of any point on the generatrix, y is the y-coordinate of any point on the generatrix;
the elliptical toroidal worm and involute cylindrical gear adopt spatially non-orthogonal transmission, and the shaft angle is determined according to the self-locking condition; the facewidth of the involute cylindrical gear is related to the working length of the elliptical toroidal worm and the shaft angle, and in order to achieve the full facewidth of the involute cylindrical gear to participate in the mesh, the following relationship should be satisfied:
b=L sin ε
where, b is the facewidth of the involute cylindrical gear, L is the working length of the elliptical toroidal worm gear;
the tooth flank of the elliptical toroidal worm is made of the involute spur gear's involute cylindrical surface or involute helical gear's involute helicoid as the tool generatrix surface according to the envelope method, and the corresponding transmission coordinate system is established according to the position relationship between the involute cylindrical gear and the elliptical toroidal worm mesh transmission; the details are as follows: the equation of the tooth flank of the involute cylindrical gear is obtained by the coordinate transformation and the principle of tooth conjugate meshing of the elliptical toroidal worm; the transmission subsets are ground and shaped with hard tooth material, so the equations of the tooth surface on the upper side of the elliptical toroidal worm are as follows:
$$\{ \begin{matrix}\begin{matrix}{x}_{2 L} = ( {x}_{1 L} cos {φ}_{1} - {y}_{1 L} sin {φ}_{1} - a ) cos {φ}_{2} + \\ [ ( {x}_{1 L} sin {φ}_{1} + {y}_{1 L} cos {φ}_{1} ) cos ε + {z}_{1 L} sin ε ] sin {φ}_{2}\end{matrix} \\ \begin{matrix}{y}_{2 L} = [ ( {x}_{1 L} sin {φ}_{1} + {y}_{1 L} cos {φ}_{1} ) cos ε + {z}_{1 L} sin ε ] cos {φ}_{2} - \\ ( {x}_{1 L} cos {φ}_{1} - {y}_{1 L} sin {φ}_{1} - a ) sin {φ}_{2}\end{matrix} \\ {z}_{2 L} = - ( {x}_{1 L} sin {φ}_{1} + {y}_{1 L} cos {φ}_{1} ) sin ε + {z}_{1 L} cos ε \\ {x}_{1 L} = {r}_{b} cos τ + {r}_{b} u sin τ \\ {y}_{1 L} = - {r}_{b} sin τ + {r}_{b} u cos τ \\ {z}_{1 L} = {α}_{1} {ρ}_{1} λ + {α}_{2} {h}_{L} \\ τ = u - {σ}_{0} - {α}_{1} λ \\ {h}_{L} = \frac{{r}_{b} ( {i}_{12} - cos ε ) + a cos ( u - {σ}_{0} - {φ}_{1} ) cos ε}{- sin ( u - {σ}_{0} - {φ}_{1} ) sin ε} \\ u = \frac{\begin{matrix}- {r}_{b}^{2} cos ( τ - {φ}_{1} ) sin ε + {ρ}_{1}^{2} ( τ + {σ}_{0} ) sin ( τ - {φ}_{1} ) sin ε - \\ {ρ}_{1} a cos ( τ - {φ}_{1} ) cos ε - {r}_{b} {ρ}_{1} ( {i}_{12} - cos ε ) + {r}_{b} a sin ε\end{matrix}}{( {r}_{b}^{2} + {ρ}_{1}^{2} ) sin ( τ - {φ}_{1} ) sin ε}\end{matrix}$$
where, a is the spread center distance, φ₁ is the rotation angle of the involute cylindrical gear, φ₂ is the rotation angle of elliptical toroidal worm, i₁₂ is the reciprocal of the transmission ratio of the worm gear pair, σ₀ is half of the base circular angle corresponding to the transverse base thickness of the involute cylindrical gear, u is the rolling angle formed by the dominant involute tooth profile;
similarly, the equations of the lower side tooth surface of the elliptical toroidal worm are as follows:
$$\{ \begin{matrix}\begin{matrix}{x}_{2 R} = ( {x}_{1 R} cos {φ}_{1} - {y}_{1 R} sin {φ}_{1} - a ) cos {φ}_{2} + \\ [ ( {x}_{1 R} sin {φ}_{1} + {y}_{1 R} cos {φ}_{1} ) cos ε + {z}_{1 R} sin ε ] sin {φ}_{2}\end{matrix} \\ \begin{matrix}{y}_{2 R} = [ ( {x}_{1 R} sin {φ}_{1} + {y}_{1 R} cos {φ}_{1} ) cos ε + {z}_{1 R} sin ε ] cos {φ}_{2} - \\ ( {x}_{1 R} cos {φ}_{1} - {y}_{1 R} sin {φ}_{1} - a ) sin {φ}_{2}\end{matrix} \\ {z}_{2 R} = - ( {x}_{1 R} sin {φ}_{1} + {y}_{1 R} cos {φ}_{1} ) sin ε + {z}_{1 R} cos ε \\ {x}_{1 R} = {r}_{b} cos ( τ ) + {r}_{b} u sin ( τ ) \\ {y}_{1 R} = {r}_{b} sin ( τ ) - {r}_{b} u cos ( τ ) \\ {z}_{1 R} = {α}_{1} {ρ}_{1} λ + {α}_{2} {h}_{R} \\ τ = u - {σ}_{0} + {α}_{1} λ \\ {h}_{R} = \frac{{r}_{b} ( {i}_{12} - cos ε ) + a cos ( u - {σ}_{0} + {φ}_{1} ) cos ε}{sin ( u - {σ}_{0} + {φ}_{1} ) sin ε} \\ u = \frac{\begin{matrix}- {r}_{b}^{2} cos ( τ + {φ}_{1} ) sin ε + {ρ}_{1}^{2} ( τ + {σ}_{0} ) sin ( τ + {φ}_{1} ) sin ε - \\ {ρ}_{1} a cos ( τ + {φ}_{1} ) cos ε - {r}_{b} {ρ}_{1} ( {i}_{12} - cos ε ) + {r}_{b} a sin ε\end{matrix}}{( {r}_{b}^{2} + {ρ}_{1}^{2} ) sin ( τ + {φ}_{1} ) sin ε}\end{matrix}$$
the above tooth equations are determined by two parameters φ₁ and u, other parameters are known, and upper tooth surface and lower tooth surface of elliptical toroidal gear vice can be obtained by MATLAB numerical analysis and 3D modeling software in the range of φ₁ and u, and then they are stitched with the top toroidal surface and root toroidal surface of elliptical toroidal worm to generate the 3D solid model of non-orthogonal elliptical toroidal worm gear pair, and finally the non-orthogonal elliptical toroidal worm gear pair is obtained.
